(19) United States
(12) Patent Application Publication
(10) Pub. No.: US 2011/0186384 A1
(43) Pub. Date: Aug. 4, 2011

(54) MOTOR AND METHOD OF OPERATION

(76) Inventor: John Lee Vega, Hebron, IN (US)

(21) Appl. No.: 13/019,565

(22) Filed: Feb. 2, 2011

Related U.S. Application Data
(60) Provisional application No. 61/300,650, filed on Feb. 2, 2010.

(51) Int. Cl. F03G 1/00

(52) U.S. Cl. 185/37

(57) ABSTRACT

A motor and method of operating the motor to produce a rotational output. The motor includes first and second springs that are paired with each other so that as one of the springs is storing mechanical energy the other spring is releasing mechanical energy during a cycle of the motor. A gear system couples the springs so that an output of the first spring assists in storing mechanical energy in the second spring and an output of the second spring assists in storing mechanical energy in the first spring. First and second output gears are coupled to the first and second springs, respectively. The first output gear produces a rotational output from the output of the first spring as the first spring releases its mechanical energy, and the second output gear produces a rotational output from the output of the second spring as the second spring releases its mechanical energy.

### CROSS REFERENCE TO RELATED APPLICATIONS

This application claims the benefit of U.S. Provisional Application No. 61/222,545, filed Jul. 2, 2009, and U.S. Provisional Application No. 61/300,650, filed Feb. 2, 2010. The contents of these prior patent documents are incorporated herein by reference.

### BACKGROUND OF THE INVENTION

The present invention generally relates to motors, and more particularly to a motor comprising a plurality of mechanical springs that work in combination with each other to produce a continuous rotational output that offers improvements in efficiency over traditional motors.

There is a need for motors that do reduce or eliminate the reliance on fossil fuels as input energy source, so as to reduce dependence on fossil fuels as well as reduce the amount of pollutants discharged into the environment.

### BRIEF DESCRIPTION OF THE INVENTION

The present invention provides a motor and a method of operating the motor to produce a rotational output.

According to a first aspect of the invention, the motor includes at least first and second springs that are paired with each other in an opposing manner so that, as one of the first and second springs is storing mechanical energy, the other of the first and second springs is releasing mechanical energy during a cycle of the motor. A gear system couples the first and second springs so that an output of the first spring assists in storing mechanical energy in the second spring and an output of the second spring assists in storing mechanical energy in the first spring. First and second output gears are coupled to the first and second springs, respectively. The first output gear is adapted to produce a rotational output from the output of the first spring as the first spring releases the mechanical energy thereof, and the second output gear is adapted to produce a rotational output from the output of the second spring as the second spring releases the mechanical energy thereof.

Another aspect of the invention is a method of producing a rotational output in a shaft using the motor described above. The method includes coupling the first and second output gears to the shaft and alternatingly imparting rotation to the shaft with the first and second output gears.

A technical effect of this invention is that the rotational output is generated by the motor with the assistance of springs that mutually cooperate to store and release energy, the latter of which is then used to create and/or maintain the rotational output as well as store mechanical energy in the springs. The motor can be utilized in a wide variety of applications, for example, for the production of electricity, propulsion, pneumatic applications, and mechanical applications, to name a few.

Other aspects and advantages of this invention will be better appreciated from the following detailed description.

### BRIEF DESCRIPTION OF THE DRAWINGS

FIG. 1 is a schematic of a motor in accordance with an embodiment of this invention.

FIG. 2 is an end view of a spring shown in of FIG. 1.

FIG. 3 is a schematic of the motor of FIG. 1 used as the power source of a power output shaft.

### DETAILED DESCRIPTION OF THE INVENTION

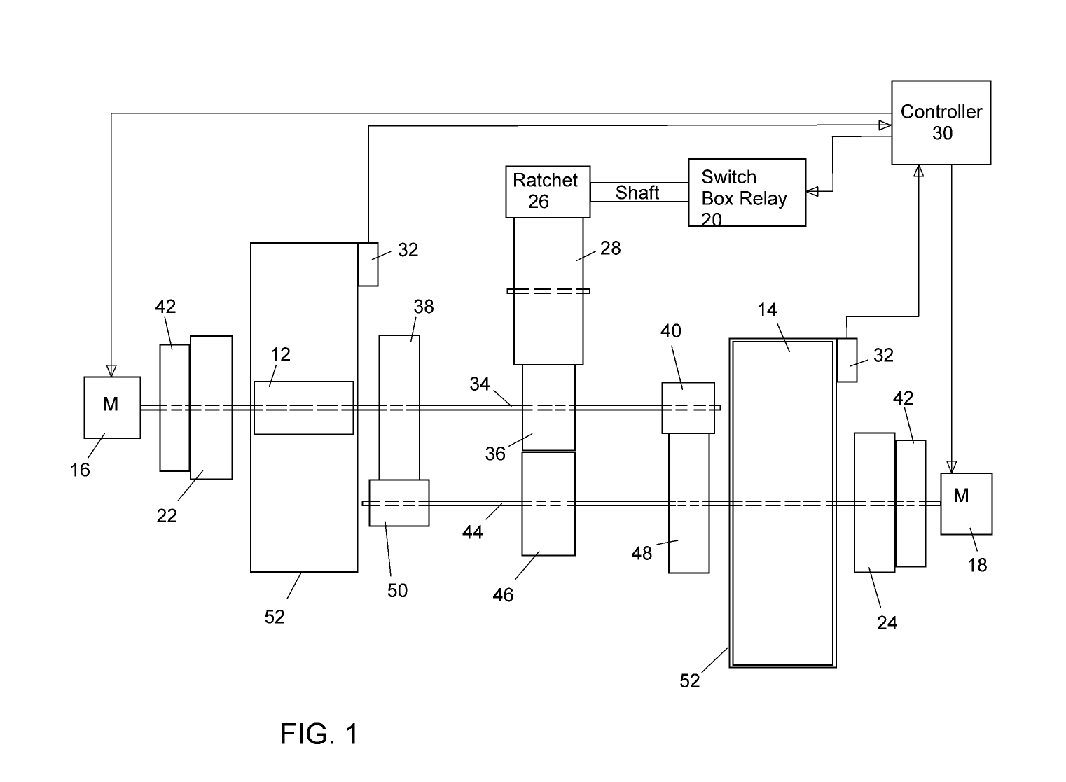

FIG. 1 schematically represents a motor 10 utilizing mechanical springs 12 that work in combination with each other. Two springs 12 and 14 are represented as being paired with each other, though it is foreseeable that the motor 10 could employ any number of springs, and that such springs might not be provided in pairs but could be provided in sets containing more than two springs. The springs 12 and 14 are arranged in an opposing manner, which as used herein refers their interconnection so that they store and release mechanical energy in an alternating manner, with one spring storing and the other releasing energy during a given cycle. The springs 12 and 14 illustrated in FIG. 1 are coil springs, and are therefore adapted to store and release mechanical energy through contraction (coiling) and expansion (uncoiling). As such, as the spring 12 contracts to store energy, the other spring 14 is simultaneously expanded to release energy, and vice versa. Other types of springs are also within the scope of the invention, including torsional springs, helical springs, etc.

For illustrative purposes, the spring 12 is represented in a fully contracted (coiled) state in FIG. 1, whereas the spring 14 is represented in a fully expanded (uncoiled) state. As such, the spring 12 has stored mechanical energy that can be released. This energy is used by the motor 10 to produce a rotational output at an output gear 22 associated with the spring 12, as well as assist in the contraction of the spring 14. Similarly, in the next cycle of the motor 10, the mechanical energy that was stored in the contracted spring 14 can be released to produce a rotational output at an output gear 24 associated with the spring 14, as well as assist in the contraction of the spring 12. For this purpose, the springs 12 and 14 are represented in FIG. 1 as interconnected through a gear system so that each spring 12/14 tightens its partner spring 12/14 during each contraction-expansion cycle. In order to ensure that each spring 12 and 14 is fully contracted during a cycle so as to cause its partner spring 12 or 14 to fully expand in the next cycle, a supplemental mechanical or electrical input device will be necessary to compensate for mechanical losses. For this purpose, supplemental input devices are represented in FIG. 1 as motors 16 and 18 mounted on shafts 34 and 44 to which the springs 12 and 14 are mounted, respectively.

To initiate operation of the motor 10, a mechanical or electrical starter device is preferably provided, a suitable example of which is represented by the switch box electrical relay 20 in FIG. 1. The input of the relay 20 is supplied through a ratchet 26 or other suitable device, which initiates and permits rotation of an input gear 28 in a rotational direction selected by an input of a controller 30 to the relay 20. The controller 30 can be of any suitable type, and can be part of a computer system that allows an operator to control the operation of the motor 10. The controller 30 employs sensors 32 (for example, proximity sensors) to monitor the state (expansion or contraction) of each spring 12 and 14, as well as controls the supplemental motors 16 and 18 so that their supplemental rotational inputs are supplied to the motor 10 only as needed to complete the contraction of its corresponding spring 12 or 14.

The shaft 34 on which the spring 12 (fully-contracted in FIG. 1) is mounted also carries a gear 36 meshed with the input gear 28, a pair of gears 38 and 40 to either side of the gear 36, and the output gear 22. The shaft 44 on which the spring 14 (fully-expanded in FIG. 1) is mounted also carries a gear 46 meshed with the gear 36 on the shaft 34, a pair of gears 48 and 50 to either side of the gear 46, and the output gear 24. The springs 12 and 14 and gears 38 and 48 are keyed or otherwise fixedly attached to their respective shafts 34 and 44. In contrast, the gears 22, 24, 36, 40, 46 and 50 are freewheeling in one direction so that only the rotation of the shafts 34 and 44 induced by the uncoiling of their respective springs 12 and 14 is transmitted to the output gears 22 and 24, the output gears 22 and 24 rotate in the same direction, and the shafts 34 and 44 are able to freely rotate in the direction required to contract their respective springs 12 and 14. As such, as the fully contracted spring 12 uncoils, the spring 12 rotates its shaft 34, causing the gears 22, 38 and 40 to rotate with the shaft 34 and without interference from the gears 40 and 46. The gear 38 drives the gear 50, which causes the shaft 44 to rotate and coil the other spring 14. Subsequently, as the fully contracted spring 14 uncoils, the spring 14 rotates its shaft 44, causing the gears 24, 48 and 50 to rotate. The gear 50 drives the gear 38, which causes the shaft 34 to rotate and coil the other spring 12. In this manner, the paired springs 12 and 14 cause their respective shafts 34 and 44 to rotate back and forth in an alternating manner, but their rotational outputs to the output gears 22 and 24 are continuously in the same rotational direction.

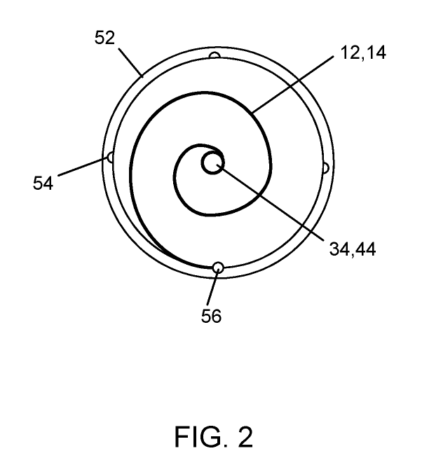

FIGS. 1 and 2 show the springs 12 and 14 mounted in drums 52. FIG. 2 represents retention recesses 54 located on the internal perimeter of the drum 52. The recesses 54 are adapted to engage and retain a retention feature 56 attached to the outer end of each spring 12 and 14 during coiling and uncoiling of the springs 12 and 14. The retention feature 56 is free to disengage the recess 54 in which it is retained to prevent over-torquing of the springs 12 and 14 while they are being coiled by the other spring 12 and 14 and/or their respective motors 16 and 18.

The controller 30 controls the relay 20 to initiate the operation of the motor 10, monitors the motor 10 and in particular the expansion/contraction states of the springs 12 and 14, and energizes the motors 16 and 18 to the extent necessary to fully wind the springs 12 and 14 during each of the contraction cycles, so that the rotational output of the motor 10 does not decay from to mechanical losses due to friction, etc. Flywheels 42 are shown mounted on the output gears 22 and 24 to serve as rotational energy storage devices.

From the foregoing, it can be appreciated that a series of springs can be arranged to compound the effect of energy release to produce a rotational output with greater torque. In addition, springs other than coil/torsional springs may be employed depending on the final configuration desired. It is also foreseeable that a transmission or clutches may be employed to effectively distribute the energy produced by the springs 12 and 14.

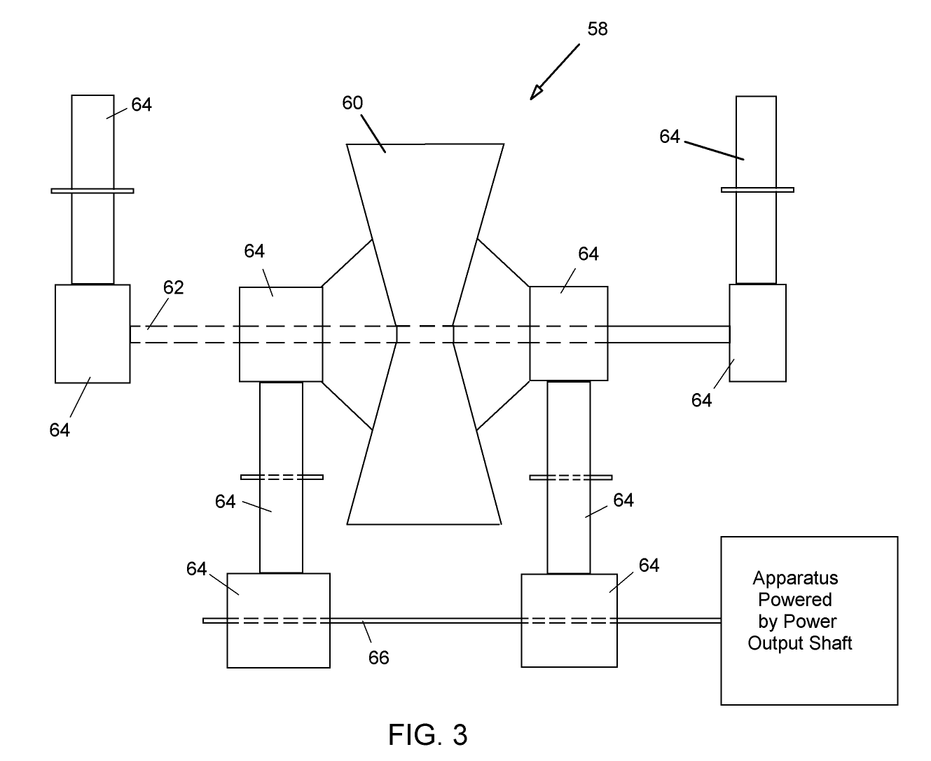

FIG. 3 represents the motor 10 coupled to a transmission 58, which includes a large flywheel 60 mounted on a shaft 62, and gears 64 that transfer the rotational outputs of the motor output gears 22 and 24 to a power output shaft 66. This shaft 66 may be used to propel a vehicle, generate energy, or any other application where a rotational input can be used.

While the invention has been described in terms of a specific embodiment, it is apparent that other forms could be adopted by one skilled in the art. For example, the physical configuration of the gear train could differ from that shown. Furthermore, the components of the motor 10 are not to scale, and components of various sizes could be used to achieve desirable gear ratios and other potential advantages. Therefore, the scope of the invention is to be limited only by the following claims.

1. A motor comprising:
at least first and second springs paired with each other in an opposing manner so that as one of the first and second springs is storing mechanical energy the other of the first and second springs is releasing mechanical energy during a cycle of the motor;
a gear system coupling the first and second springs so that an output of the first spring assists in storing mechanical energy in the second spring and an output of the second spring assists in storing mechanical energy in the first spring; and
first and second output gears coupled to the first and second springs, respectively, the first output gear being adapted to produce a rotational output from the output of the first spring as the first spring releases the mechanical energy thereof, the second output gear being adapted to produce a rotational output from the output of the second spring as the second spring releases the mechanical energy thereof.

2. The motor according to claim 1, wherein the first and second springs are coil springs and the outputs of the first and second springs are rotational outputs.

3. The motor according to claim 1, wherein the first and second output gears are coupled to a shaft and cooperate to alternating impart rotation to the shaft.

4. A method of producing a rotational output in a shaft using the motor according to claim 1, the method comprising coupling the first and second output gears to the shaft and alternatingly imparting rotation to the shaft with the first and second output gears.
